(19) United States
(12) Patent Application Publication
(10) Pub. No.: US 2026/0116710 A1
(43) Pub. Date: Apr. 30, 2026

(54) Simplifying for an Operator to Handle a Crane of a Container Lifting System

(71) Applicant: ABB Schweiz AG, Baden (CH)

(72) Inventors: Dawid Ziobro, Västerås (SE); Gayathri Gopalakrishnan, Eskilstuna (SE); Simon Hallstadius Linge, Västerås (SE)

(73) Assignee: ABB Schweiz AG, Baden (CH)

(21) Appl. No.: 19/371,131

(22) Filed: Oct. 28, 2025

(30) Foreign Application Priority Data
Oct. 29, 2024 (EP) 24209567

(51) Int. Cl. B66C 13/48; B66C 13/40; B66C 15/06

(52) U.S. Cl. CPC B66C 13/48; B66C 13/40; B66C 15/065

(57) ABSTRACT

A method managing a group of cranes of a container lifting system, a container lifting management device as well as a container lifting system. The cranes have different selectable operational states comprising manual control, supervised autonomous control and unsupervised autonomous control. A container lifting management device displays a supervisory view of the group of cranes to at least one operator, in which supervisory view the operation of the cranes is visualized, analyses the behavior of the different cranes and suggests or implements a change in operational state of at least one of the cranes based on the analyzed behavior.

### CROSS-REFERENCE TO RELATED APPLICATIONS

The instant application claims priority to European Patent Application No. 24209567.7, filed October 29, 2024, which is incorporated herein in its entirety by reference.

### FIELD OF THE DISCLOSURE

The present disclosure is generally directed to a method, computer program and computer program product for managing a group of cranes of a container lifting system, a container lifting management device as well as a container lifting system.

### BACKGROUND OF THE INVENTION

As crane systems become more intelligent their abilities extend providing new opportunities to make crane operations more autonomous. For a crane operator this might imply a smaller workload or need for manual intervention, but there are dangerous side effects like boredom and meaningless supervision tasks. The challenge arises in how to create a meaningful job with stimulating tasks. A solution addressing that problem is to channel workload from multiple cranes and assign operator(s) to simultaneously supervise multiple cranes.

CN102491206 describes a tower crane monitoring system, which comprises single-crane monitoring units and a multiple-crane centralized monitoring unit. The single-crane monitoring units are used for onsite monitoring management of single tower cranes and transmitting the monitoring information to the multiple-crane centralized monitoring unit and connected with a GPRS (general packet radio service) public network. The multiple-crane centralized monitoring unit is used for monitoring information of all the onsite single-crane monitoring units in a centralized manner and controlling onsite tower cranes.

### BRIEF SUMMARY OF THE INVENTION

In one aspect, the present disclosure describes a method for managing a group of cranes of a container lifting system, where the cranes have different selectable operational states comprising manual control, supervised autonomous control and unsupervised autonomous control, the method being performed by a container lifting management device and comprising: displaying a supervisory view of the group of cranes to at least one operator, in which supervisory view the operation and (the operational states) of the cranes is visualized, analyzing the behavior of the different cranes, and suggesting or implementing a change in operational state of at least one of the cranes based on the analyzed behavior.

In another aspect, the present disclosure describes a container lifting management device comprising a processor operative to: display a supervisory view of a group of cranes to at least one operator, in which supervisory view the operation of the cranes is visualized and where the cranes have different selectable operational states comprising manual control, supervised autonomous control and unsupervised autonomous control, analyze the behavior of the different cranes, and suggest or implement a change in operational state of at least one of the cranes based on the analyzed behavior.

In yet another aspect, the present disclosure describes a container lifting system comprising the group of cranes and the container lifting management device according to another aspect.

In another aspect, the present disclosure describes a computer program for managing a group of cranes of a container lifting system, where the cranes have different selectable operational states comprising manual control, supervised autonomous control and unsupervised autonomous control, the computer program comprising computer program code which when run by a processor causes the processor to: display a supervisory view of a group of cranes to at least one operator, in which supervisory view the operation of the cranes is visualized, analyze the behavior of the different cranes, and suggest or implement a change in operational state of at least one of the cranes based on the analyzed behavior.

In another aspect, the present disclosure describes a computer program product for managing a group of cranes of a container lifting system, where the cranes have different selectable operational states comprising manual control, supervised autonomous control and unsupervised autonomous control, the computer program product comprising a data carrier with the computer program according to another aspect.

### BRIEF DESCRIPTION OF THE SEVERAL VIEWS OF THE DRAWINGS

FIG. 1 is a schematic of a container lifting system comprising a group of cranes, each connected to a corresponding crane control device, a number video capturing systems, each associated with a corresponding crane as well as a container lifting management device, in accordance with the disclosure.

FIG. 2 is a diagram of one embodiment of the container lifting management device in accordance with the disclosure.

FIG. 3 is a diagram of a computer program product in the form of a CD ROM with computer program code used to implement a container lifting management function of the container lifting management device in accordance with the disclosure.

FIG. 4 is a flowchart for a method of managing the group of cranes of the container lifting system in accordance with the disclosure.

FIG. 5 is a schematic of a container vessel to or from which a container is being lifted using a crane in accordance with the disclosure.

FIG. 6 is a diagram of a supervisory view presented to an operator by the container lifting management device in a supervisory visualization mode in accordance with the disclosure.

FIG. 7 is a schematic of a manual intervention view presented to the operator by the container lifting management device in a manual intervention visualization mode in accordance with the disclosure.

FIG. 8 is a flowchart of further method steps in the method of managing the group of cranes of the container lifting system in accordance with the disclosure.

### DETAILED DESCRIPTION OF THE INVENTION

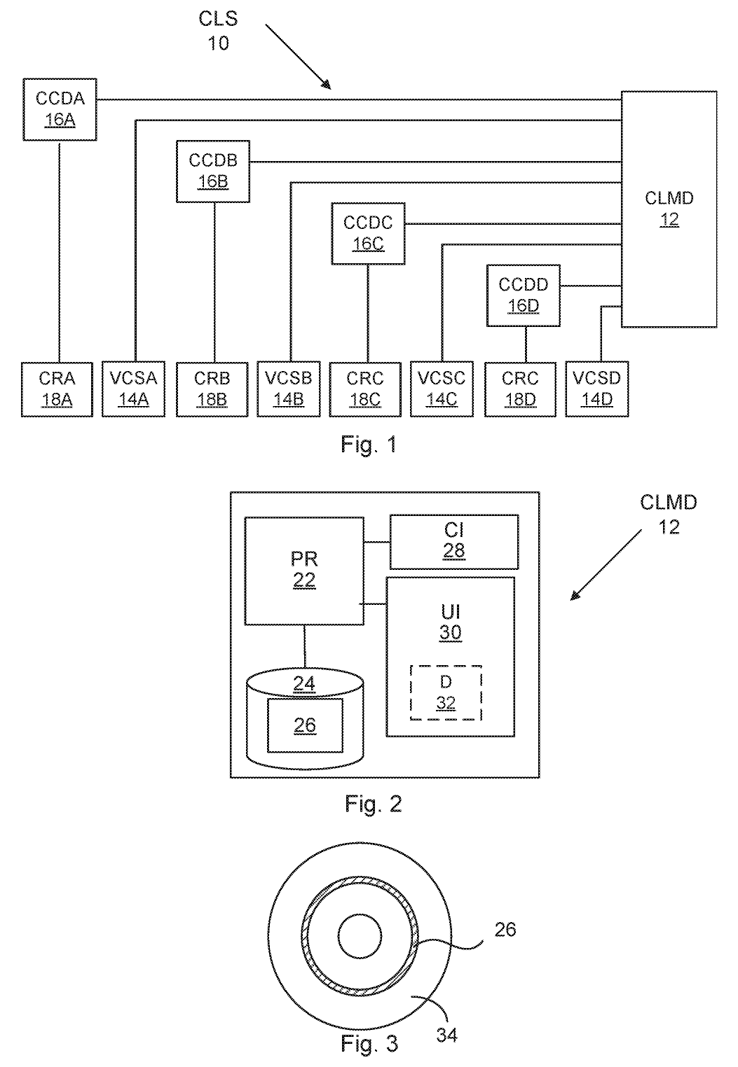

FIG. 1 schematically shows a container lifting system 10 that comprises a container lifting management device CLMD 12, a group of cranes, a group of crane control devices and a group of video capturing systems. As an example, there is a first crane CRA 18A connected to a first crane control device CCDA 16A, a second crane CRB 18B connected to a second crane control device CCDB 16B, a third crane CRC 18C connected to a third crane control device CCDC 16C and a fourth crane CRD 18D connected to a fourth crane control device CCDD 16D. The first crane control device 16A controls the first crane 18A, the second crane control device 16B controls the second crane 18B, the third crane control device 16C controls the third crane 18C and the fourth crane control device 16D controls the fourth crane 18D. There is also a group of video capturing systems 14A, 14B, 14C, 14D, each being associated with a corresponding crane 18A, 18B, 18C, 18D in the group of cranes. Thus, there is a first video capturing system VCSA 14A associated with the first crane 18A, a second video capturing system VCSB 14B associated with the second crane 18B, a third video capturing system VCSC 14C associated with the third crane 18C and a fourth video capturing system VCSD 14D associated with the fourth crane 18D. Each video capturing system may comprise one or more video cameras mounted on or at the corresponding crane and at least one video camera is mounted on the corresponding crane and provides a primary video stream having a field of view covering at least a part of the crane, such as a spreader of the crane.

Thus, the group of cranes comprises the first crane 18A, the second crane 18B, the third crane 18C and the fourth crane 18D, the group of crane control devices comprises the first crane control device 16A, the second crane control device 16B, the third crane control device 16C and the fourth crane control device 16, while the group of video capturing systems comprises the first video capturing system 14A, the second video capturing system 14B, the third video capturing system 14C and the fourth video capturing system 14D. There may be further video capturing systems, such as a quay video system covering one or more quays at which the cranes operate. The crane control devices 16A, 16B, 16C, 16D and the video capturing systems 18A, 18B, 18C, 18D are all connected to the container lifting management device 12. There may also be more as well as fewer cranes and crane control devices.

A crane control device 18 may be a controller, such as a Programmable Logic Controller (PLC) used to control the operation of a corresponding crane, like controlling the crane to lift or hoist objects like containers.

FIG. 2 schematically shows one realization of the container lifting management device CLMD 12. The container lifting management device 12 comprises a processor PR 22 and a data storage 24 with a computer program 26 comprising computer program instructions that, when executed by the processor 22, implements a container lifting management function. The container lifting management function implements container lifting management functionality of the container lifting management device 12. There is also a first communication interface CI 28, here realized as an Ethernet interface, for communicating with the crane control devices 16A, 16B, 16C, 16D and video capturing systems 14A, 14, 14C, 14D.

The processor 22 is also connected to a user Interface UI 30 or HMI (Human Machine Interface) via which an operator may make inputs and be presented with information about the operation of the crane lifting system 10. For this reason, the user interface 30 may comprise a display D 32, which may with advantage be realized as a touch-screen. However, it is also possible that the user interface comprises other means of inputting data such as a keyboard, a keypad, joystick and/or a track ball.

The container lifting management device 12 may thus comprise a processor 22 with associated program memory 24 including a computer program 26 with computer program code for implementing the container lifting management function with the container lifting management functionality.

A computer program may also be provided via a computer program product, for instance in the form of a non-transitory computer readable storage medium or data carrier, like a CD ROM, a memory stick or a memory card, carrying such a computer program with the computer program code, which will implement the container lifting management function when being run by a processor. One such computer program product in the form of a CD ROM 34 with the above-mentioned computer program 26 comprising computer program code is schematically shown in FIG. 3. The container lifting management device 12 may manage the group of cranes 18A, 18B, 18C, 18D.

The cranes may additionally have a number of different selectable operational states comprising manual control, supervised autonomous control, unsupervised autonomous control and standby, where a crane that is in the manual control state is controlled by an operator, a crane that is in the supervised autonomous control state is controlled by a crane control device under the supervision of an operator, a crane that is in the unsupervised autonomous control state is controlled by a crane control device without supervision, it is thus not supervised by any operator, and a crane that is in the standby state is in standby or is idle.

The container lifting management function of the container lifting management device 12 may additionally have a crane pool management mode. In the crane pool management mode, the cranes may be assigned to the different operational states. A crane may thus be assigned to an operator for operator control in the manual control state, to an operator for supervising autonomous operation of the crane the supervised autonomous control state or not be assigned to any operator at all in the unsupervised autonomous control and standby states, such as operating autonomously without being supervised or being idle. In the crane pool management mode, it is additionally possible to change the operators that supervise or control a crane. It is also possible for a crane to switch between different operational states.

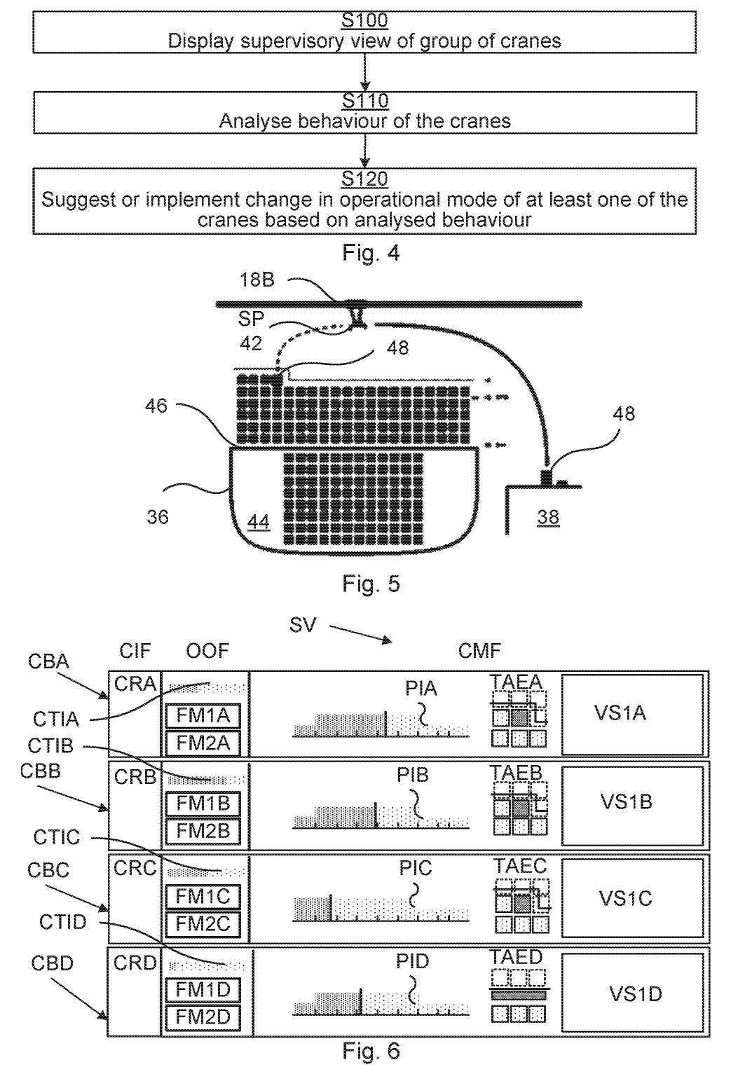

This provides flexibility in the control in that some operators may be selected to monitor one or more cranes and/or to control one or more cranes, some cranes may be operated autonomously with or without supervision and some cranes may be idle. Thereby it is possible to tailor the operator’s involvement to the actual need. For instance, an operator performing crane control of one crane may have a limited ability to supervise other cranes, while an operator that only performs supervision may supervise several more cranes. However, the operation of a crane may be unsmooth. There is therefore a need to provide flexibility when the cranes are in operation. Therefore, aspects of the present disclosure are directed towards making the operational state changes dynamic. How this can be done will now be described with reference also being made to FIG. 4, which shows a number of steps in a method of managing the group of cranes of the container lifting system 10.

The container lifting management function may display a supervisory view of the group of cranes to at least one operator, S100. The display may be made to one or more operators on one more display of the container lifting system. The operation of the cranes may be visualized in the view. The display may involve displaying data concerning all cranes in the group irrespective of the state they are operating in. Also, the operational states of the cranes may be visualized in the view. The states may for instance be visualized using different colors.

It is also possible that the cranes of some of the states are omitted from the supervisory view, such as cranes that are in the idle state and/or operate in the operator control state. It is also possible that the supervisory view is limited to cranes operating in autonomous control states being displayed, such as the supervised autonomous control state and unsupervised autonomous control state.

The cranes that operate in an autonomous control state or under manual control may more particularly operate or be controlled in an operations cycle. In this case it is possible that the progress of the operation of the crane in the operations cycle is displayed.

The container lifting management function may also analyze the behavior of the cranes in the group, S110, as well as suggest or implement a change in operational state of at least one of the cranes based on the analyzed behavior, S120. The container-lifting management function may thus suggest a change in operational state based on the analysis. It may for instance suggest that an unsupervised crane is to be supervised or vice versa. It may also or instead suggest that an autonomously operating crane is to be operator controlled or vice versa, where such a suggestion may be displayed on one or more of the displays to one or more of the operators. As another alternative, the container lifting management function may itself change state. It may thus change a crane from being unsupervised to being supervised. As an example, this may be done if the crane is about to engage in an operation that has had a statistical high level of issues. In this case the container lifting management function may also select operator that is to supervise the crane in question. A crane operator may for instance be selected based on skill, experience, and role as well as on the number of cranes he or she monitors. The container lifting management function may the select a suitable operator before changing of state into the supervised state. It can in this case also change a crane from being supervised to being unsupervised, for instance if the crane has become idle. It may also or instead change an autonomously operating crane to being operator controlled or vice versa.

The analysis may comprise detecting an issue in the operation of the crane, such as detecting a problem in the operation of the crane, and changing operational state based on this detection. If a change of operation involves a change from an unsupervised to a supervised state, then the analysis may also involve an analysis of the skills, experiences, roles, the number of cranes each operator supervises and select a suitable operator based on this analysis. Alternatively, the analysis may comprise detecting that an issue is finished being handled, such as if a problem in the operation has been solved. As mentioned above, the change of state may be linked to detection of an issue in the operation of a crane. For this reason, there will now follow a discussion about such operation, starting with reference being made to FIG. 5.

FIG. 5 schematically shows the second crane 18B that moves a container 48 to or from a cargo vessel 36. As can be seen in FIG. 5, the second crane 18B may be equipped with a spreader SP 42 used to move a container 48 from a quay 38 to a cargo vessel 36 or from the cargo vessel 36 to the quay 38, where the container 48 may be lifted from or to a road chassis of a truck on the quay 38 and where the lifting may be done using flippers of the spreader 42. It is possible that a container is placed inside a hatch 44 or on a deck 46 of the cargo vessel 36. In order to be placed inside the hatch 44, it may be necessary to open hatch covers. Furthermore, a container may be locked to the vessel, other containers and/or road chassis using locking mechanisms such as twist locks.

The lifting of containers to or from a cargo vessel using cranes may in the unsupervised autonomous control state and supervised autonomous control state be made automatically under the control of crane control devices. In the supervised autonomous control state one or more operators supervise this operation. The container lifting management device 12 may provide a supervisory visualization mode in which one or more operator gets an overview of a group of cranes. It is additionally possible that the supervisory visualization mode provides an overview of the automatic crane control of a group of cranes, i.e. a view of cranes operating in supervised autonomous control state or unsupervised autonomous control state. It also provides other visualization modes of which at least some can be selected by the operator.

As was mentioned earlier, there may be issues occurring during crane operation. It is for instance possible that the wrong container is being picked up. There may also be issues with hatch covers. These may be closed when they are supposed to be open, or vice versa. They may also be locked when they should be unlocked or vice versa. There may also be issues with twist locks or spreader flippers. A twist lock may be locked when it should not and a spreader flipper may have the wrong orientation. It is also possible that persons may be discovered in safety zones, such as safety zones around areas such as target areas where containers are to be placed or from where they are to be lifted.

Aspects of the present disclosure are directed towards simplifying for an operator to handle such issues.

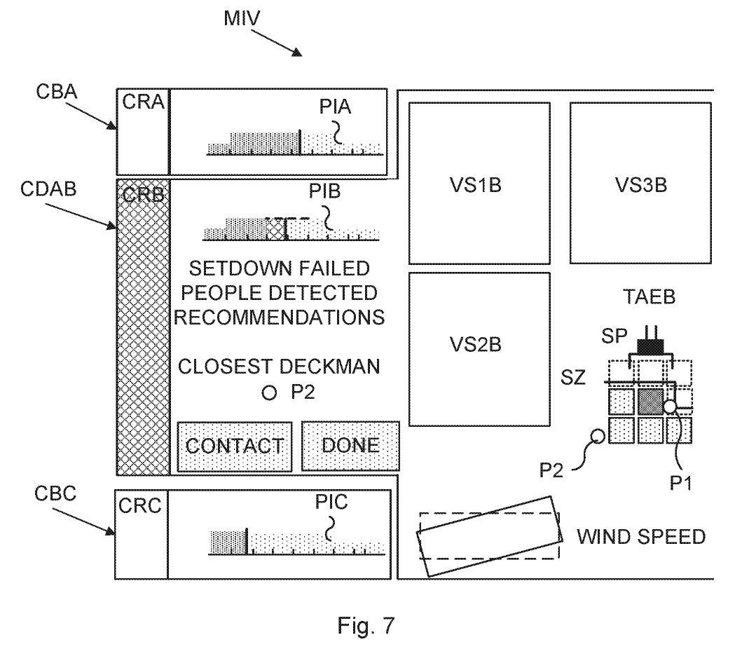

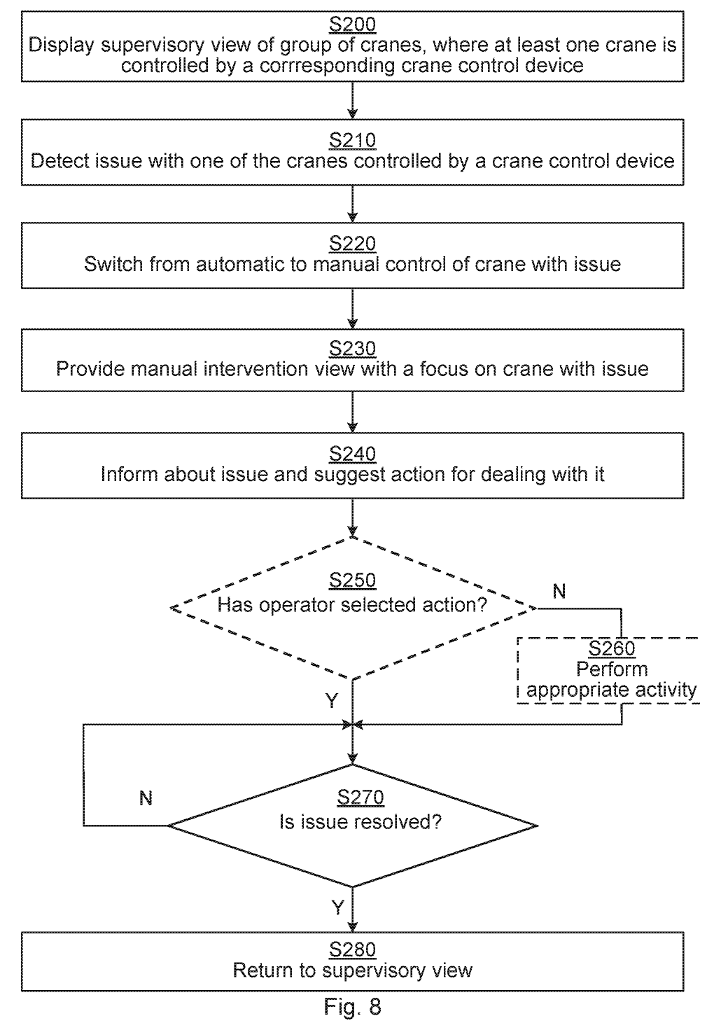

How this may be done will now be described in more detail with reference being made to FIG. 6, 7 and 8, where FIG. 6 schematically shows the supervisory view presented to an operator by the container lifting management device, FIG. 7 schematically shows a manual intervention view presented to the operator by the container lifting management device, and FIG. 8 shows a flow chart of a number of method steps in a variation of the method of managing a group of cranes of a container lifting system. In this case the method may additionally be considered to be a method of simplifying for an operator to handle at least one crane of the container lifting system.

The container lifting management function of the container lifting management device may provide the crane pool management mode. In the crane pool management mode one or more operators may be assigned a group of cranes in order for the operator(s) to be able to monitor the group. As an example, a first operator may be assigned the group comprising the first, second, third and fourth cranes, 18A, 18B, 18C, 18D. In this example all the cranes are in the supervised autonomous control state.

Thereby, a first operator may be responsible for a group of cranes, where each crane is controlled by a corresponding crane control device.

A crane may be equipped with a number of sensors, and the crane may supply signals of these sensors to the corresponding crane control device. Also, different views of the crane and target areas may be provided by the video capturing system associated with the crane. One or more of these views may also cover the crane spreader. A crane control device may control a corresponding crane based on such sensor signals. The operation is typically cyclical and specified in a work order. Therefore, a crane control device may control a crane to move a crane spreader to a target lifting area, identify a container at the target lifting area, lock the spreader to the container, move the container from the lifting area to a target delivery area, place the container at the target delivery area and unlock the spreader from the container. Another type of cycle involves moving the crane spreader to a hatch and opening or closing the hatch. One of the target areas is typically an area on a cargo vessel, such as an area on or below deck of the vessel and the other target area is typically an area on a quay, for instance on a road chassis located on the quay.

A first operator may need to monitor this type of operation and for this reason the container lifting management function may provide a supervisory visualization mode in which a supervisory view is displayed to the first operator. FIG. 6 shows one example of such a supervisory view SV.

As can be seen in FIG. 6, the supervisory view SV may as an example comprise a number of bar shaped windows or crane bars, where each is dedicated to one crane in the group assigned to the first operator or operators. A window may here comprise a crane identification field CIF, an operations overview field OOF and a current movement field CMF.

The crane identification field CIF shows an indication of the crane. It can also show a status of the operation of a cycle, for instance through a color such as green for a crane that functions properly or another color, such as yellow or red, if there is some issue with the current cycle. The field may also display other information, such as alternatives for transferring a crane in the group from the first operator to another operator, such as a second operator. It is also possible to indicate which operator, if any, is assigned for supervising the crane.

The operations overview field OOF may show a completion time indicator, which indicates how long the cycle is as well as how much of the cycle that has been completed by the crane, i.e. how far into the cycle the crane has come at a current point in time, i.e. a time to completion of the cycle.

The container lifting management function may have knowledge about the time of a current cycle from previous cycles. It may also predict the time of the current cycle based on one or more previous cycles. The determining of how much of the cycle has been completed may be determined based on measuring the time that has elapsed since the start of the cycle.

The operations overview field OOF may also show following moves to be made by the crane, i.e. the operations that are to be made in following cycles, such as which containers are to be lifted and moved in following cycles, from where they are the be lifted and where they are to be placed.

The current movement field CMF may show a progress indicator, which is an indicator of the progress of the current cycle. This may show a number of consecutive steps in the cycle, for instance along a horizontal line. The progress indicator may also indicate which step the crane is currently at, for instance through a vertical line that moves along the horizontal line as each step is being performed, which movement may be from left to right.

Each step may be shown as a square shaped area having one of two heights in the vertical direction above the horizontal line, where a first lower height or level above the horizontal line may indicate that the crane is above the quay and a second higher height or level may indicate that the crane is above a cargo vessel. At least some of the areas may also comprise symbols indicating the type of operation being made in the step. A symbol may also be omitted from a step, for instance if the same operation is performed in the step as in a previous step. The operations may include the operations moving a crane between a quay and a cargo vessel for reaching a target lifting area, which movement may be divided into two steps one above the quay and the other above the cargo vessel, lowering the spreader of the crane to a target lifting area, locking the spreader to a container at the target lifting area, identifying the container at the target lifting area, raising the spreader and moving the crane with the container between the cargo vessel and the quay for reaching a target placing area, which movement may likewise be divided into two steps, one above the quay and another above the vessel. Similar types of movements and symbols may exist for opening and closing a hatch.

The target lifting area may be either on the quay or on the vessel and the target placing area may be either on the vessel or on the quay. A target area on a vessel can additionally be above or below deck.

The current movement field CMF may also show a view of a current target area environment, i.e. an environment of an area in which the container of the cycle is to placed or from where it is to be lifted. Put differently, a target area is an area that is to be handled, where the handling involves placing a container in the target area or lifting a container from the target area.

This view of the environment of the current target area may also show neighboring container areas, which container areas may be shown as previous target areas having already been handled and/or following target areas that are about to be handled, where a previous target area is an area that was a target area before the current target area, i.e. in a previous cycle, and a following target area is a target area that will be handled in the future, i.e. an area that will become a target area after the current target area. There may also be a safety zone around the current target area, which safety zone may consider if the neighboring target areas are previous or following target areas.

Finally, there is a set of video streams associated with the cranes 18A, 18B, 18C, 18D showing at least one video stream comprising a primary video stream having a view covering the spreader of the crane, which may additionally be a video stream that covers and shows a view in the direction of movement of the spreader.

The exemplifying supervisory view shown in FIG. 6 is a supervisory view of the previously mentioned group of cranes comprising the first, second, third and fourth cranes 18A, 18B, 18C, 18D.

For the first crane 18A there is shown a first crane bar CBA with a crane identifying field CIF identifying the first crane CRA, an operations overview field OOF showing a first completion time indicator CTIA and first following moves FM1A, FM2A as well as a current movement field CMF with a first progress indicator PIA, a first target area environment TAEA and a first set of video streams from the first video capturing system 14A, which first set comprises at least one primary video stream VS1A. For the second crane 18B there is shown a second crane bar CBB with a crane identifying field CIF identifying the second crane CRB, an operations overview field OOF showing a second completion time indicator CTIB and second following moves FM1B, FM2B as well as a current movement field CMF with a second progress indicator PIB, a second target area environment TAEB and a second set of video streams from the second video capturing system 14B, which second set comprises at least one primary video stream VS1B. For the third crane 18C there is shown a third container bar CBC with a crane identifying field CIF identifying the third crane CRC, an operation overview field OOF showing a third completion time indicator CTIC and third following moves FM1C, FM2C as well as a current movement field CMF with a third progress indicator PIC, a third target area environment TAEC and a third set of video streams from the third video capturing system 14C, which third set comprises at least one primary video stream VS1C. For the fourth crane 18D there is shown a fourth container bar CBD with a crane identifying field CIF identifying the fourth crane CRD, an operation overview field OOF showing a fourth completion time indicator CTID and fourth following moves FM1D, FM2D as well as a current movement field CMF with a fourth progress indicator PID, a fourth target area environment TAED and a fourth set of video streams from the fourth video capturing system 14D, which fourth set comprises at least one primary video stream VS1D.

The supervisory view is shown when the cranes operate satisfactorily, which can be indicated via the crane identifying field, for instance through the field having a special color like green.

From this view it may be possible for the first operator to select a field and if this is done he may enter a detailed visualization mode, in which he or she may be presented with further information about the crane. If for instance the current movement field CMF is selected, the operator may be presented with further information about the current move. After the operator has seen the information he or she is interested in, he or she may go back to the supervisory visualization mode and the supervisory view SV.

Furthermore, when in the supervisory view SV, an issue may occur in relation to a crane.

It is for instance possible that the wrong container has been lifted. A container may additionally have the wrong orientation during the move, for instance because of wind. This may stop it from being placed at the corresponding target placing area. As another example, the twist lock of a container that is to be lifted from a target lifting area may accidentally be locked to an underlying surface, such as to the deck, another container or a road chassis. It is also possible that there are people inside the safety zone around a target area. It is also possible that the target area is inside a hatch, the covers of which are not open. They may even be locked. All these situations are examples of issues that may occur. Aspects of the present disclosure are directed towards simplifying for a crane operator to handle such issues.

The container lifting management function may initially provide the supervisory visualization mode where each crane is controlled by a corresponding crane control device and where the supervisory view SV of the group of cranes is displayed to the operator that performs the supervision, S200. Thus, a supervisory view SV of the group of cranes 18A, 18B, 18C, 18D is displayed, in which view the operation of the group of cranes is visualized. Furthermore, at least one of the cranes in the group, is controlled by a corresponding crane control device in the group of crane control devices 16A, 16B, 16C, 16D. With advantage all of the cranes in the group are controlled by corresponding crane control devices.

There is also an analysis of the behavior of the cranes. In this case the investigating of the behavior involves the container lifting management function detecting that there is an issue with one of the cranes, S210. The container lifting management function may obtain data from the crane control devices and/or video capturing arrangements, analyze this data and determine the issue based on the analysis. The data may comprise signals from the crane control device, such as detected wind speeds, crane positions and crane movement speeds as well as images from the different video capturing systems, which images may then be analyzed. An issue may then be identified via the images and/or through investigating the signals received from the crane control devices. It is also possible that the container lifting management device 12 receives positions of persons around the target area, for instance through GPS transmitters on the persons or position signals transmitted by wireless terminals of these persons. Such a position can then be compared with the target position of a currently handled container in order to determine if the position is within the safety zone of the currently handled container. Alternatively, the presence of a person may also be detected in a video stream of the video capturing system.

The container lifting management function may provide recommendations to the operator for handling the issue. The container lifting management function may for instance suggest a change of operational states based on the detected issue.

Moreover, when an issue is detected for a crane, this may be signaled in the supervisory view SV through changing the status of the crane identifying field. It is also possible that the status is indicated in the current step of the progress indicator. Moreover, there is a switch from automatic to manual control of the crane, S220. There is thus a switch from the crane being controlled by the corresponding crane control device to manual control by a corresponding operator. Thereby the container lifting management function implements a change in operational state of the crane. Thus, there is a switch from the supervised autonomous control state to another state, which in this case is the manual control state, where the operator controls the crane for which an issue is detected. The container lifting management function may for instance put the automatic control performed by the corresponding crane control device on hold and instead hand over control to the first operator. The crane experiencing the issue may thus in this case be controlled by the first operator instead of the corresponding crane control device. For this crane that experiences a change in operational state, there may also be a corresponding change in visualization mode.

As an example, there may be an issue with a second crane 18B, which may be signaled in the second crane bar CBB and/or in the second progress indicator PIB and the control of the second crane 18B is moved from the second crane control device 16B to the operator.

For the crane experiencing the issue there is thus also change from the supervisory visualization mode to the manual intervention visualization mode. Furthermore, in the manual intervention visualization mode, the container lifting management function provides a manual intervention view with a focus on the crane that experiences the issue, S230, for allowing the operator to address the issue.

One example of such a manual intervention view MIV for the second crane 18B is shown in FIG. 7, when there is an issue with the second crane 18B.

Here there is a first and third crane bar CBA and CBC for the first and third cranes 18A, 18C with limited information compared with the supervisory view SV. As an example, they only comprise the crane identifying fields and the current movement fields, which current movement fields only comprise the progress indicators PIA, PIC. Thus, the video streams and/or target areas may be omitted.

The first and third cranes, which have no issues in the current cycles, can then be continued to be controlled by the first and third crane control devices 16A, 16C and their operation can still be monitored by the first operator.

As can be seen in FIG. 7, there is no fourth crane bar in the manual intervention view MIV. The monitoring of the fourth crane could have been moved to another operator in order to allow a better focus on the issue at hand. However, it should be realized that the fourth crane bar could also be retained with limited information in line with the first and third crane bars CBA, CBC.

In the manual intervention view MIV, the crane experiencing the issue is provided in an expanded crane display area that corresponds to an expanded current movement field. In the given example the second crane 18B was the crane experiencing the issue. Therefore, the second crane bar CBB is expanded into a crane display area CDAB as compared with the supervisory view. The crane display area CDAB may comprise the crane identifying field, which may be set to indicate that there is an issue, for instance through showing a color associated with the issue, such as yellow, orange or red. The color may be linked to the severity of the issue. The operations overview field may additionally be omitted from the crane display area CDAB. However, the crane display area CDAB may comprise the progress indicator PIB. It is here possible that the progress indicator PIB signals the issue in the current step as well as possibly in the following step. This signaling can be made through highlighting or a special color of parts of the squared shape area that have been covered in the current step and through providing a line with the same highlighting or color above the rest of this square shaped area and the square shaped area of one or more following steps.

The crane display area CDAB may also comprise an expanded current target area environment TAEB, where if the spreader SP is close to the current target area also the location of the spreader SP in relation to the current target area may be indicated, if the spreader is close it. The current target area may be displayed together with the previous and following target areas. Also, the safety zone SZ around the current target area may be indicated, which safety zone may pass through the following target areas in the neighborhood of the current target area. It is possible that the safety zone covers the current target area and neighboring previous target areas as well as goes through the following target areas that border the current target area.

If there are orientation problems for a container that is to be placed in the target area, it is also possible to show the relationship between the container orientation and the target area as well as other information, such as wind speed and/or wind direction. The crane display area CDAB may also show information identifying the issue as well as suggestions for its handling.

In the example in FIG. 7, a container has failed to be set down in the target area and a reason for this is that persons have been detected inside the safety zone SZ. Thus. The crane 18B is supposed to handle a container at a current target area. However, the container lifting management function has detected positions of people at or around the current target area and these positions are such that one or more persons are located within the safety zone around the current target area, where additionally the safety zone passes may through a number of neighboring target areas that are to be handled in following cycles. The container lifting management function may additionally determine a person at or around the current target area that is to handle the issue and also set up a communication session between the first operator and this person.

As an example, the target area may be on a deck of the container vessel and the recommendation may be to connect to the closest person with manager duties, which is here a deckman. The first operator is also provided with a button CONTACT that he or she can use to connect to this deckman. The position of the person P1 detected inside the safety zone SZ as well as the position of the deckman P2 may also be displayed. As an example, these positions are displayed in relation to the target area environment TAEB.

The positions can be obtained using positioning services, such as GPS. It is also possible to detect positions of persons in one or more video streams using image recognition. The deckman may additionally be equipped with a cellular phone, for instance a smartphone and a communication session may be set up between the operator and the deckman via the container lifting management device and the terminal of the deck man. Information about the deckman may be obtained from a database.

There are typically also multiple video streams being shown, which may all show different scenes of an area where the issue occurs. The number of video streams being shown in the view MIV may be increased compared with the supervisory view SV. Their sizes may also be increased. In the example of FIG. 6, three different video streams are shown; a primary, secondary and tertiary video stream VS1B, VS2B and VS3B. These video streams may prove different views and/or zoom levels of the target area and its neighbors.

As an issue is detected, about one the cranes, S210, the container lifting management device 12 thus switches from automatic to manual control of this crane, S220, as well as provides the manual intervention view MIV that focuses on the crane with the issue, S230. In this case it is also possible that the container lifting management function orders the video capturing system associated with the crane to change view used in at least one of the video streams, such as in the primary video stream VS1B. The second video capturing system 14B may comprise a number of video cameras at least one of which is mounted on the second crane 18B. This video camera may also cover the spreader of the crane. It may thus have a field of view covering the spreader. The spreader may thus be visible in the primary video stream VS1B. Furthermore, if the spreader of the crane is moving in a direction, i.e. has a movement along a direction, the video camera view of the crane may be changed so that it becomes a wide-angle view in this direction of movement of the spreader or in a direction that is opposite to the direction of movement. Thus, the method may in this case comprise changing the field of view of the video camera so that it becomes a wide-angle view along or opposite to the direction of movement of the spreader. This simplifies for the first operator to identify the issue.

The container lifting management function may also inform the first operator about the issue as well as suggest at least one action for dealing with it, S240, where in the example of FIG. 7, the issue is a set down fail due to people having been detected in the safety zone SZ around the target area and the recommendation is to connect to the closest deckman P2.

The container lifting management device may here optionally investigate if the first operator has selected the action, S250, and perform an appropriate activity in case the operator has not, S260. One appropriate activity may be to wait until the operator has performed the action. Another may be to suggest an alternative action.

After the operator has performed the original or alternative action, the container lifting management function continues and investigates if the issue has been resolved. This check is also made if no investigations is made concerning operator action selection. In case the issue has not been resolved, S270 it is possible to return and wait until it has. If the issue has been resolved, S270, for instance through no person any longer being in the safety zone SZ, the container lifting management function may make the crane return to the supervised autonomous control state and the visualization of the crane return to the supervisory visualization mode with the supervisory view SV where the crane is automatically controlled, which may be done based on a confirmation by the operator that the issue has been resolved, for instance through the pressing of a done button DONE. It is also possible to consider the issue to be resolved through the operator considering it as being resolved, for instance through pressing the DONE button.

It can in this way be seen that an operator is assisted in resolving an issue. The switch from the supervisory autonomous control state to the manual control state may additionally be fast when an issue is encountered and thereby it is possible that dangerous situations are avoided.

The previously mentioned detailed visualization mode may provide a detailed view that is similar to the manual intervention view.

The detailed view may provide an expanded crane display area for a selected crane together with crane bars for the other cranes with limited information. The crane display area may comprise the information of the operational overview field. It may thus comprise the completion time indicator and following moves. More particularly, it may comprise more following moves than in the supervisory view. It may also include more and larger video streams as well as more information, such as wind speed and wind direction. It is also possible to schematically show where a container is to be placed in a view like that shown in FIG. 4.

Aspects of the present disclosure thus suggest a 4-part system being implemented by the container lifting management function, which system can be implemented independently or in combination and may encompass following parts.

Supervisory visualization mode: System offering simultaneous representation of multiple cranes. For each crane operational progress and status may be illustrated that can be displayed on one or several displays. The supervisory visualization mode may present operational progress that updates as the cranes operate and status of several different cranes can be presented simultaneously. The number or cranes that are displayed may vary and may also depend on the lifting needs and size of docked ship. Relevant information for each crane may be contained and visualized within a graphical element making it clear and easy to see distinction between the different cranes. Any type of graphical elements or visual separation techniques can be applied to clearly visualize the different cranes.

For each and any of the cranes various types of data may be visualized using various types of graphical elements, text, video, or other visualization means. Sound may also be used to amplify any status changes to create user awareness.

In this mode, one or several operators are assigned to supervise the same or several different cranes. Indications of who is responsible for supervising the crane may be visualized, making the accountability clear for everyone. So that not several users start taking manual control in parallel, operators or other administrators can “mark/tag” which cranes they will be focusing or operating (when needed), even though the other supervisors are collectively responsible. Status changes for each crane may illustrate various types or issues that may occur either asking user to take manual control or inform about system actions. Examples of different statuses are: crane issues of various types, if crane is in manual or automatic control, who is operating the crane, if the crane is unsupervised by any user but still in operating etc.

Main job for a crane is to relocate containers to other locations usually placing container on different vessels. A functionality encompassed in this solution calculates and visualizes duration and estimated completion time for a workorder or move in the form of a completion time indicator. This information may update continuously as the cranes operate. To prepare the operators for manual intervention or when extra attention might be required, the system may visualize and highlight this on either specific move(s) or workorders. The container lifting management function may implement an “ability assessor” may calculates the values and send the information further that is visualized in the user interface or HMI (Human Machine Interface).

The supervisory view may comprise interactive elements that provide paths to the other parts of the proposed 4-part system, allowing the operator to swiftly move back and forth between the modes/views. The interactive menu may offer operators interaction and access to various actions.

System or operator (manually) can also reorder the graphical elements representing a crane. System and operator can also reorder the crane order visualized in the supervisory mode.

Thus the supervisory visualization mode may provide simultaneous representation of several different cranes, either for one operator or several operators on one or multiple displays. Interaction paths to the other parts of the system (detailed visualization mode, manual intervention visualization mode, and crane pool management mode). Calculation and representation of estimated time until a workorder is completed (completion time indicator). Identification and representation of when manual intervention might be required, for a particular workorder or move. Representation of several and same cranes for several users. Representation of which operators/supervisors are collectively assigned to supervise a number of cranes. Representation of who is initially responsible of manually controlling a crane. This can either be visualized on several/group of cranes or a single crane. Status indication that a crane is supervised or manually controlled and by who (user profile or assigned name). Reorder of crane card elements enabled via interactive elements. Time indication and duration of when status for a crane has changed. (to see for how long a crane is waiting for possible manual intervention).

Manual intervention visualization mode: The manual intervention visualization mode offers detailed information for a single crane, allowing operator to manually control the crane in a safe way. While single crane information representation is the primary focus, this mode may also offer additional representation of other cranes, illustrating their operational progress in a condensed way. Manual intervention visualization mode may provide detailed and relevant information for an operator enabling safe and efficient control of a crane. When entering this mode the operator is taking or has choice to take manual control of a crane. This status change - from autonomous to manual - may be visualized through different color but not limited to this graphical means.

Condensed operation progress of other cranes may also be visualized in this mode (view), allowing an operator to have good overview of all the cranes he/she is responsible for. Status of other cranes and who might be controlling those can also be represented. In this mode a description about a possible issue may be visualized, easing mental decision process of selecting most appropriate actions that resolve the issue. Operational progress indication may also be visualized using the progress indicator.

In this mode suggestions about who could be contacted to help resolve issues may be visualized. The container lifting management function may implement a “personal recommender” that may gather and calculate for example, physical location of personnel, their availability, role, expertise, and other parameters to suggest the most appropriate candidate.

Interactive elements provide paths to the other parts of the proposed 4-part system, allowing user to swiftly move back and forth between the modes/views. An interactive menu offers users to interaction and access various actions.

Representation of various data types through graphical elements, text and video feeds and other means of data representation, informing user about environmental status and crane behavior. Condensed representation of operation process and status for other cranes (that user(s) is supervising). Crane status indication for example that it is manually controlled, and by who. Description of the issue that made automation ask for operator assistance. Suggestions of most appropriate personal that may assist an operator in resolving the issue. (location, role, availability, expertise). Interaction path acknowledging that issue is resolved, returning to supervisory mode, but not limited to any other direction, for example exiting the view.

Detailed visualization mode: This mode offers the operator detailed information about a crane compared to the supervisory visualization mode. Although this mode mainly shows relevant information for a single crane, it also offers additional representation of multiple cranes illustrating their operational progress in a condensed way. In this mode, the automation is still in-charge of crane operation as opposed to the manual intervention visualization mode.

Detailed visualization mode provides detailed and relevant information for the operator about a crane. The information can be represented by using any graphical means for example interactive buttons, text, video, or other graphical techniques and means, including various data types. When entering this mode, the operator is not directly taking manual control of a crane but gains more detailed information related to the health and behavior of a crane.

The workorder and future moves for a crane may also be visualized as well as an estimated completion time for a workorder through the completion time indicator.

Condensed operation progress of other cranes is also visualized in this visualization mode (view), allowing the operator to have good overview all the cranes he/she is responsible for. Status of other cranes and who might be controlling those can also be represented.

Interactive elements provide paths to the other parts of the proposed 4-part system, allowing the operator to swiftly move back and forth between the modes/views. An interactive menu offers operators to interaction and access various actions.

Representation of various data types through graphical elements, text and video feeds and other means of data representation, informing operators about environmental status and crane behavior. Condensed representation of operational process and status about other cranes (that operator(s) is supervising). Operational progress indication and status for selected crane, for example that it is manually controlled, and by who. Workorder and coming move(s) representation for a particular crane. Interaction path returning to supervisory visualization mode, but not limited to any other direction, for example exiting the view.

Crane pool management mode: It offers management features of several cranes allowing system or operators (manually) to assign one or several cranes to one or several operator profile(s) or RCS (remote control systems / displays). This system provides flexibility in managing which operator(s) should be responsible for supervising and initially taking manual control of assigned crane(s). The system also offers operators or systems to unassign or transfer responsibility for a crane to other operator(s) or the crane pool. The transfer of responsibility may be made through the container lifting management device analyzing the skills, experiences, roles, the number of cranes each operator supervises and then transfer a crane from one operator to another based on this analysis.

When a crane is in the crane pool, it can be unsupervised but still in operational state. The unsupervised state, and other states may be detected and visualized in the HMI, for instance in a supervisory view. Examples of states that the system can detect and distinguish are; crane assigned to one or several users, crane unassigned to no user or the crane pool, crane is in manual control, crane is in autonomous control, who is assigned to supervise one or several different cranes etc.

The various states may be graphically distinguished so they can be easily recognized by the operator(s). Visualization of the states can use any graphical element, texts or graphical techniques and is not limited to the examples illustrated here. States with increased safety risk may be highlighted in the HMI. Functionality to assign, move and/or unassign one or several cranes to specific displays/devices or one or several user profiles/accounts. Functionality to have cranes in an unsupervised state, even though they are operating. Where they are highlighted as objects of high severity. Aspects of the present disclosure make it possible for operators to monitor and troubleshoot multiple cranes while maintaining good situational awareness.

Separating pooling tasks into 4 modes and switching between them on demand while retaining overview can vary depending on for example, number of cranes that one or several operator are supervising, operator preferences and type of jobs that need to be performed.

The aspects also disclose a management system offering system or operator to for example, assign one or several cranes to one or several user profiles or RCS (displays). This allows an operator to interact and transition information between multiple modes (systems) thereby providing a unified workspace that offer quick and user-friendly supervision of multiple cranes and manual control of a crane.

Various aspects also have the following advantages: Representation of several cranes containing various types of information to obtain good supervision of operational process allowing assessment when to manually intervene. Visualization and interaction metaphors to enable optimal user workspace, workflow and interface across 4-part proposed solutions. More productive and efficient operations with less chance of human error. Visibility and management of manual intervention, ensuring that operations continue and cranes do not stand still. Faster resolution of operational issues and less undesired side effects. Easy to user workspace and offering swift switching between different modes (systems).

In the context of the present disclosure, the operational states of the cranes may be visualized in the supervisory view. At least one of the cranes in the group of cranes displayed in the supervisory view may be controlled by a corresponding crane control device in a group of crane control devices. The cranes may also have a standby state.

A crane that is in the manual control state is controlled by an operator, a crane that is in the supervised autonomous control state is controlled by a crane control device under the supervision of an operator, a crane that is in the unsupervised autonomous control state is controlled by a crane control device without supervision and a crane that is in the standby state is in standby or is idle.

The analyzing may comprise detecting an issue in the operation of the crane, such as detecting a problem in the operation of the crane, and changing operational state based on this detecting. Alternatively, the analyzing may comprise detecting that an issue is finished being handled, such as if a problem in the operation has been solved, and changing operational state based on this detecting.

The analyzing of the behavior of the different cranes being made in the method may comprise detecting an issue with one of the cranes being controlled by a corresponding crane control device and the suggesting or implementing a change in operational state being made in the method may comprise switching from the crane being controlled by the corresponding crane control device to manual control by a corresponding operator. If a change of operation involves a change from a crane being controlled by a corresponding crane control device to manual control by a corresponding operator, then the analyzing may also involve analyzing the skills, experiences, roles, the number of cranes each operator supervises and select a suitable operator based on the analyzing. The method may further comprise providing a manual intervention view with a focus on the crane with the detected issues for allowing the operator to address the issue.

The analyzing of the behavior of the different cranes being made by the container lifting management device may comprise detecting an issue with one of the cranes being controlled by a corresponding crane control device and the suggesting or implementing a change in operational state being made by the container lifting management device may comprise switching from the crane being controlled by the corresponding crane control device to manual control by a corresponding operator. If a change of operation involves a change from a crane being controlled by a corresponding crane control device to manual control by a corresponding operator, then the analyzing may also involve analyzing the skills, experiences, roles, the number of cranes each operator supervises and selects a suitable operator based on the analyzing. The container lifting management device may be further operative to provide a manual intervention view with a focus on the crane with the detected issues for allowing the operator to address the issue.

The container lifting system may further comprise the group of crane control devices as well as a group of video capturing systems, each video capturing system being associated with a corresponding crane in the group of cranes, and comprising a number of video cameras at least one of which is mounted on the corresponding crane, wherein the crane for which an issue is detected comprises a spreader and the video camera of the crane for which an issue is detected has a field of view covering the spreader.

In this case, the method may further comprise obtaining data from the crane control devices and/or video capturing arrangements, analyzing the data, determining the issue based on the analysis and providing recommendations to the operator for handling the issue.

In this case, the container lifting management device may be further operative to obtain data from the crane control devices and/or video capturing arrangements, analyze the data, determine the issue based on the analysis and provide recommendations to the operator for handling the issue.

The crane for which an issue is detected may comprises a spreader and the video camera of the crane for which an issue is detected may have a field of view covering the spreader. The spreader of the crane for which an issue is detected may have a movement along a direction. In this case the method may further comprise changing the field of view of the video camera so that it becomes a wide angle view along or opposite to the direction of movement of the spreader.

In this case the container lifting management device may be further operative to change the field of view of the video camera so that it becomes a wide angle view along or opposite to the direction of movement of the spreader. The crane may be set to handle a container at a current target area. In this case the method may further comprise detecting positions of people at or around the current target area. In this case the container lifting management device may be further operative to detect positions of people at or around the current target area.

The issue may be that one or more persons are located within a safety zone around the current target area. It is additionally possible that the safety zone passes through a number of neighboring target areas that are to be handled in following cycles. In this case the method may further comprise determining a person at or around the current target area that is to handle the issue and setting up a communication session between the operator and this person. In this case the container lifting management device may be further operative to determine a person at or around the current target area that is to handle the issue and set up a communication session between the operator and this person.

Each crane may operate in a corresponding cycle. In this case the method may further comprise determining a time to completion of the cycle. In this case the container lifting management device may be further operative to determine a time to completion of the cycle.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for managing a group of cranes of a container lifting system, where the cranes have different selectable operational states comprising manual control, supervised autonomous control and unsupervised autonomous control, the method being performed by a container lifting management device and comprising:
displaying a supervisory view of the group of cranes to at least one operator, in which supervisory view the operation of the cranes is visualized;
analyzing the behavior of the different cranes; and
suggesting or implementing a change in operational state of at least one of the cranes based on the analyzed behavior.

2. The method according to claim 1, wherein at least one of the cranes in the group of cranes displayed in the supervisory view is controlled by a corresponding crane control device in a group of crane control devices, wherein analyzing the behavior of the different cranes comprises detecting an issue with one of the cranes being controlled by a corresponding crane control device, and wherein suggesting or implementing a change in operational state comprises switching from the crane being controlled by the corresponding crane control device to manual control by a corresponding operator, and wherein the method further comprises providing a manual intervention view with a focus on the crane with the detected issues for allowing the operator to address the issue.

3. The method according to claim 2, wherein the container lifting system comprises a group of video capturing systems, each being associated with a corresponding crane in the group of cranes, and comprising a number of video cameras at least one of which is mounted on the corresponding crane, wherein the crane for which an issue is detected comprises a spreader and said video camera of the crane for which an issue is detected has a field of view covering the spreader.

4. The method according to claim 3, further comprising obtaining data from the crane control devices and/or video capturing arrangements, analyzing said data, determining the issue based on said analysis and providing recommendations to the operator for handling the issue.

5. The method according to claim 3, wherein the spreader of the crane for which an issue is detected has a movement along a direction.

6. The method according to claim 5, further comprising changing the field of view of said video camera so that it becomes a wide angle view along or opposite to the direction of movement of the spreader.

7. The method according to claim 2, wherein the crane is to handle a container at a current target area and further comprising detecting positions of people at or around the current target area.

8. The method according to claim 7, wherein the issue is that one or more persons are located within a safety zone around the current target area.

9. The method according to claim 8, wherein the safety zone passes through one or more neighboring target areas that are to be handled in following cycles.

10. The method according to claim 2, further comprising determining a person at or around the current target area that is to handle the issue and setting up a communication session between the operator and this person.

11. A container lifting system, comprising:
a group of cranes; and
a container lifting management device comprising a processor operative to:
display a supervisory view of a group of cranes to at least one operator, in which supervisory view the operation of the cranes is visualized and where the cranes have different selectable operational states comprising manual control, supervised autonomous control and unsupervised autonomous control;
analyze the behavior of the different cranes; and
suggest or implement a change in operational state of at least one of the cranes based on the analyzed behavior.

12. The container lifting system according to claim 11, wherein each crane in the group of cranes can be controlled by a corresponding crane control device of a group of crane control devices and further comprising the group of crane control devices as well as a group of video capturing systems, each video capturing system being associated with a corresponding crane in the group of cranes, and comprising a number of video cameras at least one of which is mounted on the corresponding crane,.

13. A computer program for managing a group of cranes of a container lifting system, where the cranes have different selectable operational states comprising manual control, supervised autonomous control and unsupervised autonomous control, the computer program comprising computer program code which when run by a processor causes the processor to:
display a supervisory view of the group of cranes to at least one operator, in which supervisory view (SV) the operation of the cranes is visualized,
analyze the behavior of the different cranes, and
suggest or implement a change in operational state of at least one of the cranes based on the analyzed behavior.
